(19) United States
(12) Patent Application Publication
(10) Pub. No.: US 2014/0337084 A1
(43) Pub. Date: Nov. 13, 2014

(54) METHOD AND SYSTEM FOR ASSOCIATING IT ASSETS WITH BUSINESS FUNCTIONS

(71) Applicant: VNT SOFTWARE LTD., Herzliya (IL)

(72) Inventor: Ronen YOCHPAZ, Tel Aviv (IL)

(73) Assignee: VNT SOFTWARE LTD., Herzliya (IL)

(21) Appl. No.: 13/888,416

(22) Filed: May 7, 2013

(51) Int. Cl. G06Q 10/06

(52) U.S. Cl. CPC G06Q 10/067
USPC 705/7.27; 705/348

(57) ABSTRACT

A method is provided herein, comprising identifying activated business functions being part of a business application; tracing IT assets, each being a software and/or a hardware component, running over a computerized system; associating the traced IT assets with the identified activated business function; and constructing, based on reiterated tracing and associating with respect to the business functions, a representation of an association of the IT assets with the business functions.

### BACKGROUND OF THE INVENTION

1. Technical Field

The present invention relates to the field of service and product oriented businesses, and more particularly, to mapping business applications and their inner business functions to activated software and hardware components.

2. Discussion of Related Art

Business Service Management (BSM) is an emerging concept where business applications are managed by business related functions, processes and services. BSM is becoming ever more complicated with the implementation of business applications by increasingly complex computerized systems and networks.

### BRIEF SUMMARY OF THE INVENTION

One aspect of the present invention provides a method comprising: identifying an activated one of a plurality of business functions being part of a business application; tracing a plurality of IT assets, each being a software and/or a hardware component, running over a computerized system; associating the traced IT assets with the identified activated business function; and constructing, based on reiterated tracing and associating with respect to the business functions, a representation of an association of the IT assets with the business functions and business applications.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high level schematic block diagram of a data processing system according to some embodiments of the invention;

FIG. 2 is a high level schematic flowchart illustrating a method according to some embodiments of the invention;

FIG. 3 is a high level schematic flowchart illustrating an implementation of some of the stages of the method according to some embodiments of the invention; and

FIG. 4 is a high level schematic illustration of a simplified association and the construction into the representation, according to some embodiments of the invention.

### DETAILED DESCRIPTION OF THE INVENTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

Embodiments of the current invention manage the ongoing challenge in the BSM and Information Technology (IT) management environment, to discover, identify and relate to software and hardware components associated with different business functions of the business application that serve users, e.g. over the internet, over a corporate network etc.

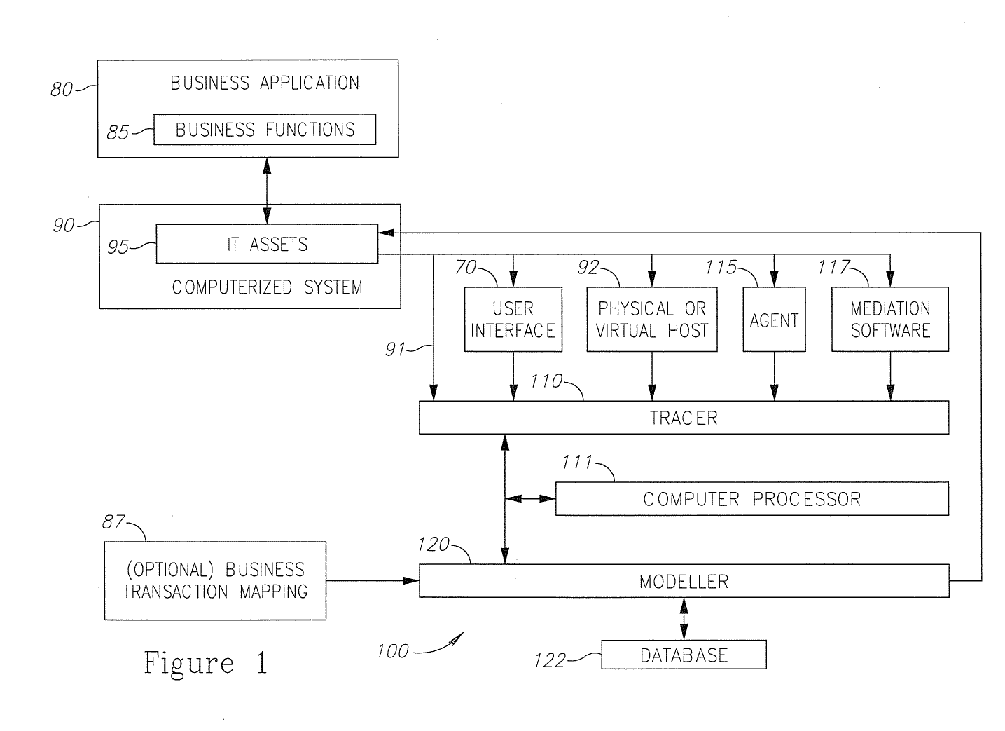

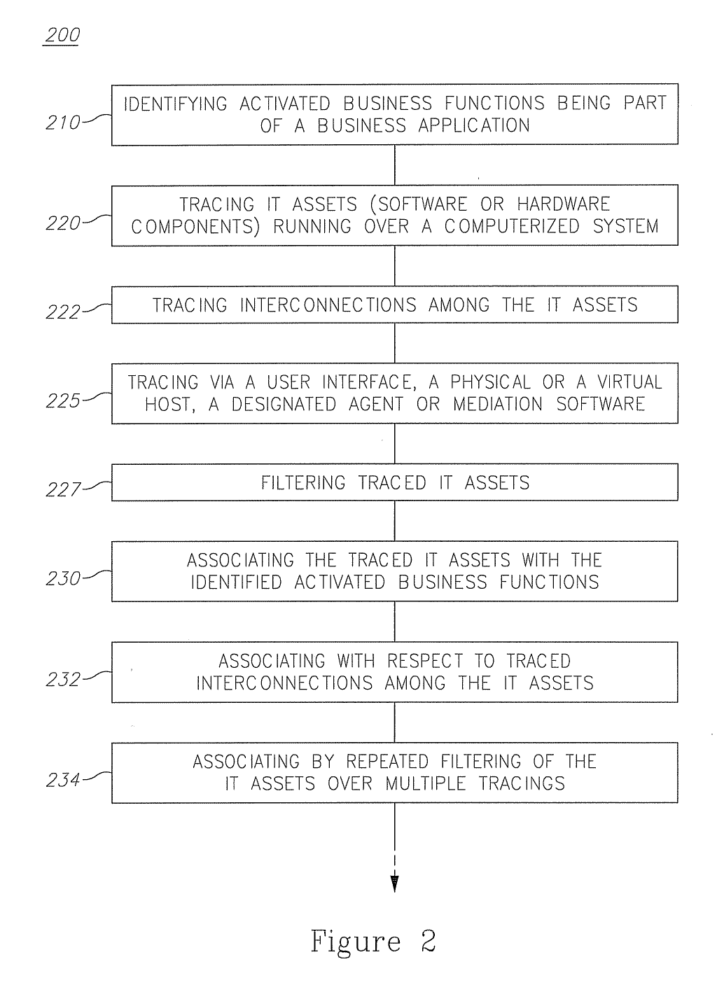

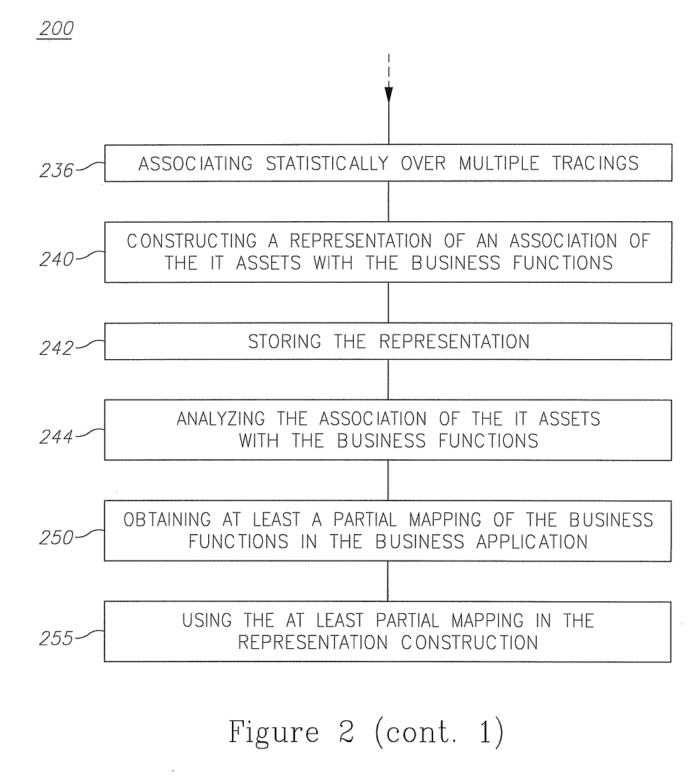

FIG. 1 is a high level schematic block diagram of a data processing system 100 according to some embodiments of the invention. Data processing system 100 is arranged to implement at least part of the stages of method 200 described in FIG. 2 and below.

Data processing system 100 comprises a tracer 110 arranged to trace a plurality of IT assets 95, each being a software and/or a hardware component, running over a computerized system 90.

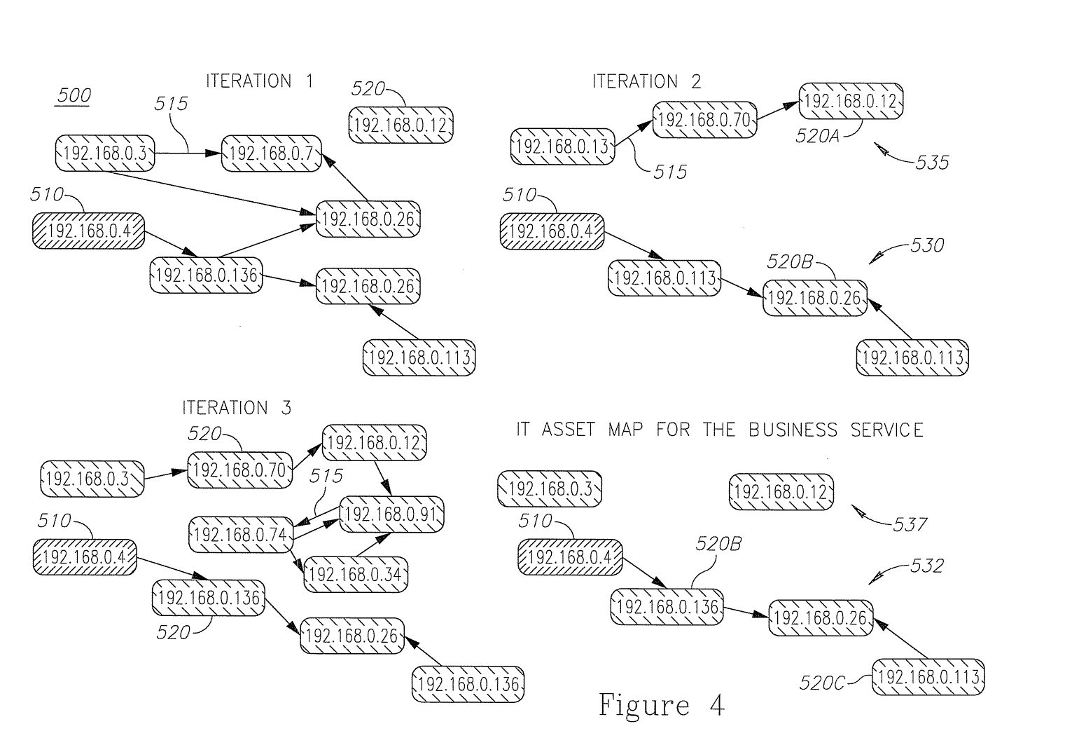

Data processing system 100 further comprises a modeler 120 arranged to identify an activated one of a plurality of business functions 85 being part of a business application 80, associate traced IT assets 95 with identified activated business function 85 and construct, based on reiterated tracing and associating with respect to business functions 85, a representation 500 (see FIG. 4) of an association of IT assets 95 with business functions 85. For example, data processing system 100 may identify hardware and/or software components that are activated when a user requests financial information and associate these components with business function 85 of information request. The exact hardware and/or software components (IT assets) that are activated may be derived by repeated tracing and extraction of common IT assets which relate to the specific business function 85.

Non-limiting examples for business application 80 may be financial applications such as banking and insurance, and non-limiting examples for business functions 85 may be transactions, orders, information requests etc.

Non-limiting examples for providers of business application 80 may be: a financial organization (e.g., banks, insurance companies), telecommunication companies, energy companies, transportation companies, utilities companies, computer companies, software companies, retail companies, healthcare companies as well as non-for-profit organizations such as governmental agencies.

Non limiting examples for IT assets comprise (i) network hardware assets, being physical servers, virtual servers or any other network device like switches, routers or firewalls; (ii) software assets, being software methods (for example Java methods), software grouping components (such as Java, .NET or other classes and packages), software packaging components (for example Jar files or assembly files), CICS transactions, database SQL statements, database stored procedures, or any other access to a software component. IT assets may further refer to any other detectable asset in the IT environment.

In embodiments, business functions 85 may be implemented by at least one of: a JVM process, a .Net CLR process, a BPEL process, a TP software transaction, an IMS transaction, a CICS transaction, a X/Open Distributed Transaction Processing (DTP), an Application Control Management System (ACMS), a Database transaction, a Java EE, a Transaction Processing Facility (TPF). In embodiments, users may interact with business functions 85 (e.g., request monetary information or transmit orders), e.g., via: a Web based user interface, a Web 2.0 based user interface, a semantic Web based user interface, a Graphical user interfaces (GUI), a Command line user interface, a Tactile user interface, a touch user interface, an attentive user interfaces, a batch user interface, a conversational Interface Agent, a crossing-based user interface, a gesture user interface, an intelligent user interface, a live user interfaces (LUI), a multi-screen user interfaces, a non-command user interface, a reflexive user interface, a tangible user interface, a text user interface, a voice user interface, a zero-input interface, a zooming user interface, a recorded script of user interface, a recorded test scenario of a user interface, a Swing based user interface, a hyperlinked document, a networked graphical user interface, a 3270 based user interface, a VT100 based user interface, a VT200 based user interface, a VT300 based user interface, a VT400 based user interface, a widgets based user interface, a menu driven based user interface, a window based user interface, a MS-windows based user interface, a Mac-OS user interface, a Linux OS user interface, a Unix based user interface, iOS user interface, Android user interface, Simbian OS user interface, or any hand held PDA user interface.

Modeler 120 may be arranged to identify business functions 85 and tracer 110 may be arranged to trace IT assets associated therewith—directly or indirectly (see below) for any of the above listed user interfaces. Modeler 120 may comprise a component that identifies business side data such as transactions and/or business functions, as well as other agents that discover the IT assets and possibly additional components.

In embodiments, software IT assets 95 may be provided with corresponding locators in a variety of environments. In addition, for each software component a filter may be specified to filter out system environment related software components. For example, in the Java environment all methods belonging to the java.* or sun.java.* packages should be filtered out. The method of connection may vary depending on the type of software component. For example, a Java process can be run under a JVM with remote debugging option under a specific port enabled. For a .Net software component, there is an agent on the host that is running the process and a connection will be made from a process modeler to a remote debugging agent.

Advantageously, system 100 is configured to trace the activated IT assets 95 in “noisy” environments, i.e., in environments that include many running software and hardware components. By repeatedly associating IT assets 95 with activated business functions 85, system 100 isolates and identifies IT assets 95 that are actually related to activated business functions 85 from the reset of the components of the noisy environments.

Tracer 110 and/or modeler 120 may be partially or fully implemented in computer hardware, e.g. in computer processor 111. Tracer 110 may be connected to computerized system 90 via any of the following components: directly 91, via a user interface 70 (e.g. the user interface used by the actual user to carry out business functions 85), a physical or a virtual host 92, an agent 115 or mediation software 117. Agent 115 may be a dedicated agent for intermediating between tracer 110 and computerized system 90.

Data processing system 100 may further comprise a database 122 for storing the representation, and modeler 120 may be further arranged to analyze the association of IT assets 95 with business functions 85 with respect to stored representations.

In embodiments, data processing system 100 may receive at least a partial business function mapping 87 with which modeler 120 may enhance the association of business function 85 with IT assets 95.

FIG. 2 is a high level schematic flowchart illustrating a method 200 according to some embodiments of the invention.

Method 200 comprises the following stages: identifying an activated one of a plurality of business functions being part of a business application (stage 210); tracing a plurality of IT assets, each being a software and/or a hardware component, running over a computerized system (stage 220); associating the traced IT assets with the identified activated business function (stage 230); and constructing, based on reiterated tracing and associating with respect to the business functions, a representation of an association of the IT assets with the business functions (stage 240). In embodiments, at least one of stages 210-240 is carried out by at least one computer processor 111.

In embodiments, tracing 220 is carried out via at least one of: a user interface, a physical or a virtual host, an agent or mediation software (stage 225). The agent may be a designated agent arranged to interface with both the computerized system and the tracing components to enable the tracing and identification.

In embodiments, method 200 may further comprise storing the representation (stage 242) and analyzing the association of the IT assets with the business functions (244). The analysis may be used to improve the representation, to learn about the structure of business functions in the business application and to identify missing information required to improve performances. By default or upon request, method 200 may further comprise obtaining at least a partial mapping of the business functions in the business application (stage 250) and using the at least partial mapping in the constructing 240 (stage 244). In case a full mapping of the business functions in the business application is obtained, e.g., by methodologically and automatically scanning the user interface (i.e., automatic crawler simulating the work of a user), the systems and methods may systematically scan business functions 85 to systematically identify all IT assets 95 associated with business application 80.

In embodiments, associating 230 is carried out statistically over multiple tracings (stage 236) or by repeated filtering of the IT assets over multiple tracings (stage 234). Associating 230 may further be assisted by formerly derived reorientations and their analysis 244 and information about the business application (e.g. obtained in stage 250).

In embodiments, tracing 220 may further comprise tracing interconnections among the IT assets (stage 222) and associating 230 may be carried out with respect to the traced interconnections (stage 232).

Embodiments of the invention comprise a computer program product comprising a computer readable storage medium having computer readable program embodied therewith, the computer readable program implementing at least some of stages 210, 220, 230 and 240 completely or partially. Additional computer readable program my implement other stages of method 200.

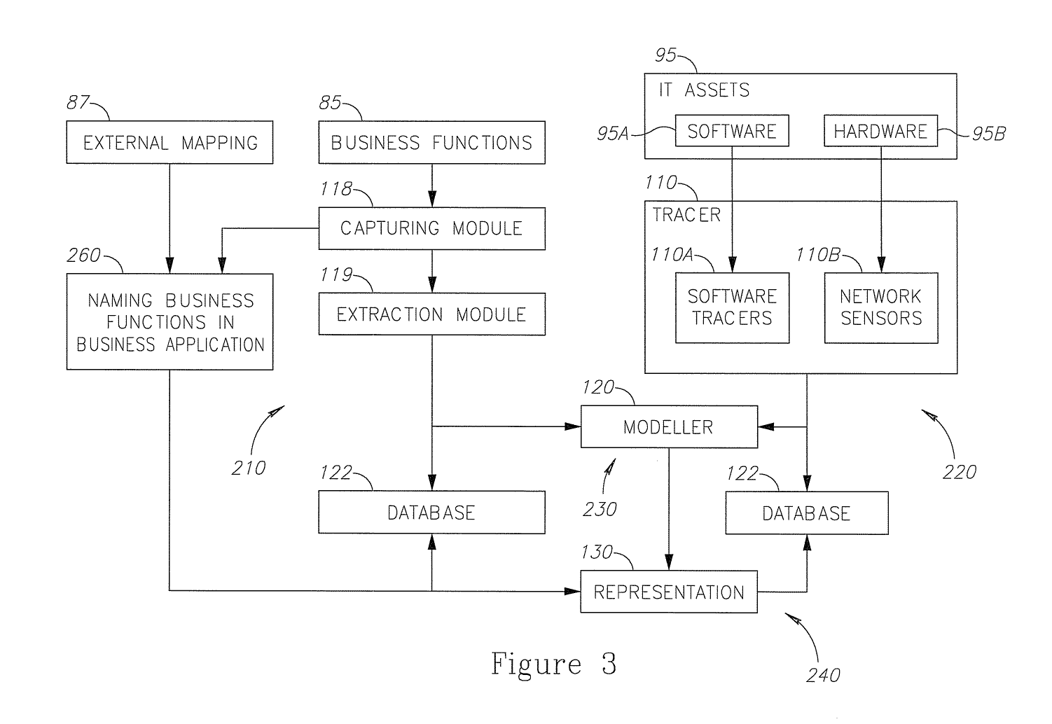

FIG. 3 is a high level schematic illustration of the operation of system 100 and method 200 according to some embodiments of the invention.

IT assets 95 such as software components 95A and hardware components 95B may be traced 220 by software tracers 110A and network sensors 110B, respectively. The information may be stored in database 122, and is transferred to modeller 120. Business functions 85 may be captured by a capturing module 118 and extracted by an extraction module 119 to transfer identified (210) activated business functions to modeller 120 and optionally stored in database 122. Capturing business functions may be carried out over various media, e.g. over the internet, corporate networks etc. Mapping and naming business functions 85 in the context of business application 80 (stage 260) may be received from external source 87 or be derived independently, with or without using captured data. Naming 260 may be integrated in identification 210 or be carried out in parallel or independently of tracing 220 and identification 210. Modeller 120 then associates the traced IT assets with the identified activated business function (230) and constructs (240), representation 130 of an association of the IT assets with the business functions. In embodiments, representation 130 integrates the names or mapping of business function 85 within business application 80.

FIG. 4 is a high level schematic illustration of simplified association 230 and construction 240 into representation 500, according to some embodiments of the invention. FIG. 4 is a non-limiting illustration for the case of network assets (servers 510, 520), assuming three invocations (iterations 1-3) of the same business function 85 (e.g. a transaction). Client host 510 and other hosts 520 communicate 515 and form graphs of exchanged messages.

Multiple invocations are grouped by the transaction type. I.e. invocations of the same transaction type are collected together. For these invocations, an intersection of the IT asset snapshots (representations of associations) is performed. This means that only IT assets participating in all invocations of the same transaction type are collected, and other IT assets are removed from the collection.

The algorithm continues the collection and intersection process, until the collected snapshot is stable for a combination of time and invocations (for example, can be configured to assume s stable collection after a minimum of 2 hours and 10 invocations that have not shown any change in the collection results).

The collected snapshot includes IT assets and connections between IT assets. Connections depend on the IT asset types. For network assets, the connections are usually calls from one server to the other over a particular port. For software assets the connections are invocations of software methods or database transactions.

Method 200 may further comprise filtering traced IT assets 227. Non-limiting examples are provided below.

Client host filtering—applies to network assets. For each business function 85 (e.g., a transaction), detecting the client of the transaction, and removing from the collected asset list (server list in this case) the servers that are not, directly or indirectly, connected to the client. This means that in the generated graph of servers and connections between servers, only servers that have a route to the client are left in the intersection result.

Directed host filtering—applies to network assets. Same as the “client host filtering” described above, but with the additional condition that the connection should be directed from the client to this host. This means that each connection between each couple of hosts on the path between the client and this host, should have the same direction, starting from the client.

Filtering is exemplified in FIG. 4 in the IT asset map (the representation of the association between IT assets 95 and business functions 85). Graphs 530, 535 illustrate the messages exchanged among hosts, with and without client host 510 respectively. Hosts 520A, which do not belong to the graph including the client host 510, may be filtered and be allocated to a group 537. Also hosts 520C, which communicate in a direction opposite to the direction of a directed graph from client host 510, may be filtered. Hosts 520B with the filtered graph of client host 510 are grouped in group 532.

In embodiments, the systems and methods implement passive asset discovery, which is a method of associating IT assets 95 to business functions 85, using passive methods that do not require user intervention and do not alter the target business function implementation. Regarding IT assets 95, the invention is not limited to network and/or software assets—any other detectable asset in the IT environment can be mapped using the methods described.

The goal is to provide a map, matching business functions 85 to IT assets 95 that are used per each business function, and also provide the connections between these IT assets (i.e., which one communicates with which one). Tagging the business context of software and/or hardware components of computerized systems of such businesses is demonstrated below with respect to software aspects and hardware aspects. Elements from software detection embodiments may be combined with elements from hardware detection embodiments.

According to some embodiments of the invention, the system can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output.

The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Embodiments of the invention may include features from different embodiments disclosed above, and embodiments may incorporate elements from other embodiments disclosed above. The disclosure of elements of the invention in the context of a specific embodiment is not to be taken as limiting their used in the specific embodiment alone.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method comprising:
identifying an activated one of a plurality of business functions being part of a business application;
tracing a plurality of IT assets, each being at least one of a software and a hardware component, running over a computerized system;
associating the traced IT assets with the identified activated business function; and
constructing, based on reiterated tracing and associating with respect to the business functions, a representation of an association of the IT assets with the business functions,
wherein at least one of the identifying, the tracing, the associating and the constructing is carried out by at least one computer processor.

2. The method of claim 1, wherein the tracing is carried out via at least one of: a user interface, a physical or a virtual host, an agent or mediation software.

3. The method of claim 1, further comprising storing the representation and analyzing the association of the IT assets with the business functions.

4. The method of claim 1, wherein the associating is carried out statistically over multiple tracings.

5. The method of claim 1, wherein the tracing the IT assets comprises tracing interconnections among the IT assets and the associating is carried out with respect to the traced interconnections.

6. The method of claim 1, wherein the associating is carried out by repeated filtering of the IT assets over multiple tracings.

7. The method of claim 1, further comprising obtaining at least a partial mapping of the business functions in the business application and using the at least partial mapping in the constructing.

8. A data processing system comprising:
a tracer arranged trace a plurality of IT assets, each being at least one of a software and a hardware component, running over a computerized system; and
a modeler arranged to identify an activated one of a plurality of business functions being part of a business application, to associate the traced IT assets with the identified activated business function and construct, based on reiterated tracing and associating with respect to the business functions, a representation of an association of the IT assets with the business functions,
wherein the tracer and the modeler are at least partially implemented in computer hardware.

9. The data processing system of claim 8, further comprising a database for storing the representation, wherein the modeler is further arranged to analyze the association of the IT assets with the business functions with respect to stored representations.

10. The data processing system of claim 8, wherein the tracer is connected to the computerized system via at least one of: a user interface, a physical or a virtual host, an agent or mediation software.

11. The data processing system of claim 8, wherein the business functions are implemented by at least one of: a JVM process, a .Net CLR process, a BPEL process, a TP software transaction, an IMS transaction, a CICS transaction, a X/Open Distributed Transaction Processing (DTP), an Application Control Management System (ACMS), a Database transaction, a Java EE, a Transaction Processing Facility (TPF).

12. A computer program product comprising a computer readable storage medium having computer readable program embodied therewith, the computer readable program comprising:
computer readable program configured to identify an activated one of a plurality of business functions being part of a business application;
computer readable program configured to trace a plurality of IT assets, each being at least one of a software and a hardware component, running over a computerized system;
computer readable program configured to associate the traced IT assets with the identified activated business function; and
computer readable program configured to construct, based on reiterated tracing and associating with respect to the business functions, a representation of an association of the IT assets with the business functions.

13. The computer program product of claim 12, arranged to carry out the tracing via at least one of: a user interface, a physical or a virtual host, an agent or mediation software.

14. The computer program product of claim 12, further comprising computer readable program configured to store the representation and computer readable program configured to analyze the association of the IT assets with the business functions.

15. The computer program product of claim 12, arranged to carry out the associating statistically over multiple tracings.

16. The computer program product of claim 12, arranged to trace the IT assets by tracing interconnections among the IT assets and to associate the traced IT assets with respect to the traced interconnections.

17. The computer program product of claim 12, arranged to carry out the associating by repeated filtering of the IT assets over multiple tracings.

18. The computer program product of claim 12, further comprising computer readable program configured to obtain at least a partial mapping of the business functions in the business application and use the at least partial mapping in the representation construction.
